(19) United States
(12) Patent Application Publication
(10) Pub. No.: US 2012/0004925 A1
(43) Pub. Date: Jan. 5, 2012

(54) HEALTH CARE POLICY DEVELOPMENT AND EXECUTION

(75) Inventors: Mark Braverman, Boston, MA (US); Mohsen Bayati, Palo Alto, CA (US); Eric Horvitz, Kirkland, WA (US); Michael Gillam, Washington, DC (US)

(73) Assignee: MICROSOFT CORPORATION, Redmond, WA (US)

(21) Appl. No.: 12/828,055

(22) Filed: Jun. 30, 2010

(51) Int. Cl. G06Q 50/00; G06F 15/18; G06N 5/02; G06Q 10/00

(52) U.S. Cl. 705/2; 706/12; 706/52; 706/47; 706/46

(57) ABSTRACT

Technology is described for developing health care policies for use in a health care facility. In one example method, a health care policy can be applied in a health care software application and stored in a health care database. A correlated feature set can be correlated to the health care policy being developed. A selection of health care cases can be obtained from the health care database for testing the health care policy. A model can predict a defined effect of the health care policy based on the correlated feature set. A cost of implementing the health care policy on a defined percentage of patients can be predicted using the defined effect by the model and a specified predictor by applying statistical analysis. The system can guide the allocation of resources in a patient-specific manner. The policies can also be applied in conjunction with user models to guide alerting.

### BACKGROUND

Health care providers desire to supply high quality health care services to patients in an economically efficient way. In order to aid in providing better health care services in a cost effective manner, health care providers and hospitals can analyze data collected about patients and related medical procedures in order to improve health care treatment. Statistics about patients can be stored in databases and then the patient data can be analyzed in order to determine what actions a health care provider can take to improve treatment for patients.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter. While certain disadvantages of prior technologies are noted above, the claimed subject matter is not to be limited to implementations that solve any or all of the noted disadvantages of the prior technologies.

Various embodiments are described for developing health care policies for use in a health care facility using health care data stored in a health care database. In one embodiment of a method, a health care policy can be obtained that is configured to be applied in a health care software application and stored in the health care database. A correlated feature set can be built from the health care database. The correlated feature set can be correlated to the health care policy being developed. Another operation can be obtaining a selection of health care cases from the health care database for testing the health care policy. A model can then be created to predict a defined effect of the health care policy based on the correlated feature set. A cost of implementing the health care policy on a defined percentage of patients can be predicted using the defined effect by the model and a specified predictor by applying statistical analysis to the health care policy and the correlated features.

### BRIEF DESCRIPTION OF THE DRAWINGS

FIG. 1 is a flowchart illustrating an embodiment of a method for developing health care policies for use in a health care facility using health care data stored in a health care database.

FIG. 2 a block diagram of an embodiment of a simplified example system used for health care support.

FIG. 3 is a block diagram of an embodiment of a system for developing health care policies for use in a health care facility using health care data stored in a health care database.

FIG. 4 is a block diagram of an embodiment of a system for developing health care policies for use in a health care facility along with the use of alerts prioritized using collaborated feedback and statistical analysis.

FIG. 5 is a block diagram of an embodiment of a system for developing health care policies including objectives and policy recommendations.

FIG. 6 is a flowchart illustrating an embodiment of a method for developing health care policies for use in a health care facility along with the use of prioritized alerts generated by collecting collaborated feedback.

FIG. 7A illustrates a table of example features from a database which may be contributing factors to a readmission probability.

FIG. 7B illustrates a table of example features from a health care database that may be mitigating features for a patient.

FIG. 8 illustrates an example output graph from an experimentation tool for decision making support.

FIG. 9 illustrates decision assistance calculations on a graph.

FIG. 10 illustrates a graph of an embodiment of a predictive model where increasing amounts of follow-up care with increasing costs can be administered to those who have the highest risk of re-admission.

### DETAILED DESCRIPTION

Reference will now be made to the exemplary embodiments illustrated in the drawings, and specific language will be used herein to describe the same. It will nevertheless be understood that no limitation of the scope of the technology is thereby intended. Alterations and further modifications of the features illustrated herein, and additional applications of the embodiments as illustrated herein, which would occur to one skilled in the relevant art and having possession of this disclosure, are to be considered within the scope of the description.

The present technology can aid health care providers and hospitals in better predicting the results of health care rules applied using information technology (IT) systems and patient care software systems. In such IT systems, a statistical modeling system can extract relevant features from a hospital information system database, and then a modeling system can determine what the expected statistical outcome may be for a certain patient or as compared to a patient population when a health care rule is applied to the selected population.

Health care providers can also develop health care rules that can be compared to existing patient records and medical treatment result data in a database. When the data for a patient is statistically correlated to the criteria determined by the model, then a health care rule can be activated and the appropriate medical decision or medical treatment can be applied to the patient.

Accordingly, a technology is provided for integrated healthcare analytics, decision support, alerts, and experimentation. Health care policies and rules can be developed for use in a health care facility. The development of the health care policies can be performed using aggregate health care data stored in a health care database representing a number of patient treatments or visits to a medical facility or hospital.

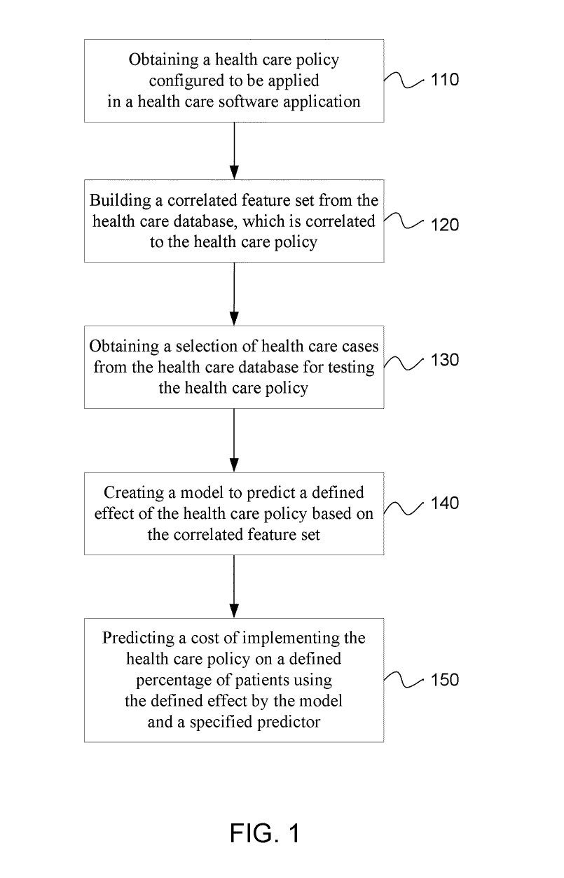

FIG. 1 illustrates an overview of an embodiment of a method for developing health care policies. The method may include obtaining a health care policy configured to be applied in a health care software application and stored in the health care database, as in block 110. A health care policy may be a health care rule with one or more health care treatment recommendations for a patient when the health care rule is triggered. Alternatively, the health care rule may trigger a request for additional data or perform analysis of additional data in the system and then provide specific alerts or output medical recommendations. The health care policies can be obtained from health care professionals (e.g., doctors and nurses), health care administrators, information technology professionals skilled in creating health care policies, or the health care policies can be rules that are inferred by an artificial intelligence engine from the existing rules and case data stored in the health care database.

A correlated feature set can be built from the health care database, as in block 120. The correlated feature set can be correlated to the health care policy being developed. The correlated feature set can be built by selecting features from the database that are related to the health care policy. For example, a feature set can be selected using a feature ranking algorithm where features that reach a certain score for important metrics are included. Alternatively, subset selection can intelligently search the entire subset for a desired subset. The correlated feature set can also be selected by a human but this can be time consuming.

A feature set for the health care cases can be encoded as a vector of binary features representing binary responses to a health care patient's possible medical symptoms and relevant medical variables. Additionally, the feature set of health care cases can be represented using other useful machine storage representations such as relational databases, object oriented databases, multi-dimensional vectors, or other storage representations.

A selection of health care cases can then be obtained from the health care database for testing the candidate health care policy, as in block 130. The selection of health care cases can be performed by randomly selecting a defined sample of health care cases from at least one database (e.g. with a sample size that is statistically relevant for the variables being studied). In one example, the data may be obtained from one database located at a hospital, clinic, or other health care facility. In another example, data from a plurality of health care facilities located at separate geographic locations can be integrated together to provide the needed medical case records. When data is used from multiple facilities, the number of cases included in the selection from each site can be weighted based on which facility the information is coming from. This may mean that more records are selected from the local facility and fewer records are selected from geographically remote facilities. Alternatively, the data from the selected records can be individually weighted based on which location they are from. For instance, the cases from the local facility can be more heavily weighted and the data from remote facilities can be more lightly weighted. In another configuration, a sample of health care cases can be selected by the type of disease that is being studied (e.g., cancer or diabetes cases).

A model can be created to help predict a defined effect of the health care policy based on the correlated feature set, as in block 140. The model used to predict the defined effect of the health care policy can be a statistical model configured to be trained using a multivariate statistical correlation model. Some examples of a multivariate statistical model that can be used include logistic regression, Naïve Bayes Classifier, Principal Component Analysis, Decision Trees, Bayesian networks, Nearest Neighbor methods, or any other suitable multivariate statistical analysis model which enables the study of the probable outcome of applying a health care policy or rule. The model used to predict health care policy effects can also use causal reasoning that is applied to features of existing health care cases in order to make inferences about the outcome of applying a health care rule and also to make links between statistical features.

A cost of implementing the health care policy on a defined percentage of patients can then be predicted using the defined effect by the model and a specified predictor by applying statistical analysis to the health care policy, as in block 150. This means the specified predictor can provide a probability that the health care rule being tested will occur. As a result, the defined effect for the policy or rule being tested can be estimated based on the statistical model, computed probability, correlated features from the database, and desired results for the model. For example, if the health care policy is a policy defining care to be provided to avoid hospital re-admittance, then the health care policy can be optimized to provide a desired balance between the cost of applying an administrative policy and the defined readmission rate.

In a further embodiment, the health care policy and correlated feature set can be tested using the selected health care cases to determine a desirable rate for applying the health care policy to health care cases at the health care facility. The desirable rate can be optimized to provide an improved outcome for the health care facility. Examples of such improved outcomes may include reduced morbidity rates, improved recovery rates, reduced treatment costs, reduced drug costs, and other desired target results.

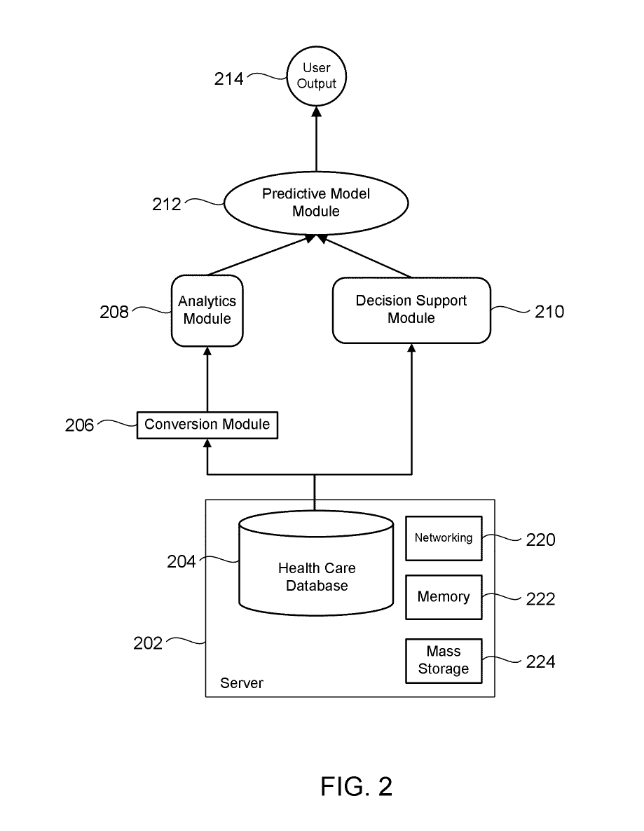

FIG. 2 illustrates a simplified example of a system used for health care support. A health care database 204 can be used by a health care provider to store a plurality of medical case records in an electronic format. The health care database can also reside on a server 202 in a medical facility or at location remote to the medical facility. The health care server can include: volatile and non-volatile memory 222 for supporting the database and modeling systems, mass storage systems such as hard drives and optical drives 224, and networking devices 220 that connect to local area networks (LANs) or connect to the internet. In one example of the server, a blade server containing many computing machines or virtual machines can be used.

As discussed previously, the present technology can use data from only a local medical system database to train the analytic models or the data can be integrated from multiple systems for training the models. More specifically, the system can integrate data from one facility, several facilities, or a large geographic area (e.g. nationwide) into the analytic models. This opportunity for integration over multiple databases helps address the reality that a certain minimum quantity of data is desirable for the analytics layer to provide meaningful results. To alleviate this problem, the system may integrate local and global data to train the analytic model. If little local data is available, the systems uses models trained on other facilities (e.g., “global models”) using the other facilities' data and analytics layers. As more local data becomes available, the local data can gradually be mixed into the global models for optimal results. A similar integration may be applied for decision support and user-generated rules.

A conversion module 206 can include a library of data parsers configured to convert the medical case records into medical data vectors. The variables or attributes of the medical case records can be converted into a binary vector or vectors of numerical values each representing an answer to a medical question. The conversion module can include or load a library of code modules (i.e., parsers) that convert the data available within the database into standardized “features” either binary or otherwise. Examples of features for a case record can include answers to questions such as: age, sex, whether there was heart failure, or other medical symptoms.

An analytics module 208 can create a model to predict a defined effect of the health care policy based on a correlated feature set. For example, the model provides the ability to predict the probability that a given feature will be present, based on the other features which are available. The model can be also configured by users to build predictive models to target a feature or feature set. Further, the analytic module can execute on top of a computerized health care provider (e.g., hospital) information management solution.

A decision support module 210 can be configured to obtain a selection of existing medical case records for testing the health care policy. These records may be selected randomly in order to automatically generate a randomized test over records in a certain area of medical health, or a query can be used to retrieve medical records based on certain criteria to study a certain type of test group. The analytics module may also include a causality module configured to provide logical medical rules linking defined medical features to medical outcomes based on causality.

The decision support module 210 can also aid in information acquisition. The system can provide a model of utility of information, such as reducing uncertainty in a given feature or set of features. The system also has a model for the cost of acquiring information (e.g. administering a test). Based on these utility models, the system can make a recommendation on which information may be most valuable for medical providers to acquire next. The recommendation can be integrated into an automated interview and triage process or the recommendation may be displayed at more advanced stages of clinical diagnosis and treatment. For example, questions generated for the health care provider can be automatically analyzed so when one question is answered, the system determines which next question is most important based on a computed probability for the case. In a more detailed example, the system can evaluate a cost of a medical test and the system can experimentally determine how likely a blood test is to be useful. This enables the system to predict for a health care administrator how useful the provided information is to the diagnosis of the patient and to decide whether to administer the test. Accordingly, the system can predict the probability of possible outcomes when a specific test is performed. Then the system can calculate the expected cost of administering the test. The expected cost for not administering the test can also be computed, which then allows the system to give a recommendation toward the lower expected cost for the best expected outcome.

A predictive model module 212 can test a health care policy with the correlated feature set using the data from selected medical case records in the health care database. The test can aid in determining a desirable application rate for implementing the health care policy at the health care facility. The results of the test can be viewed as user output 214 that is viewable to an end user. If the health care policy results in a desirable outcome as defined by health care providers, then the end user can apply that health care policy to future cases.

The conversion module 206, analytics module 208 decision support module 210, predictive model module 212 can be located on an independent server or execute on a remote computing cloud. Alternatively, these modules can be located on the server 202 described in FIG. 2.

In one embodiment, the technology also provides decision support for treatment administration. The system allows users to define utility profiles for different features representing the cost for applying a feature to a patient. More specifically, the system allows users to define utility profiles for outcomes and procedures. These profiles specify the utility of various features in terms of the utility value being positive. For example, the utility of the feature “treatment X administered” is the cost of treatment X. The utility of the feature “no readmission after 30 days” represents the cost savings from not having a readmission. For example, the cost of administering treatment X equals the cost of setting feature “treatment X administered” to 1, or the cost of a certain outcome feature can be profiled (e.g. “readmission after 30 days”=1). Based on the utility profiles and predictions on features with an undetermined cost, the system makes decision suggestions along with presenting the expected benefit from implementing the recommendation and the confidence margins for the expected benefit.

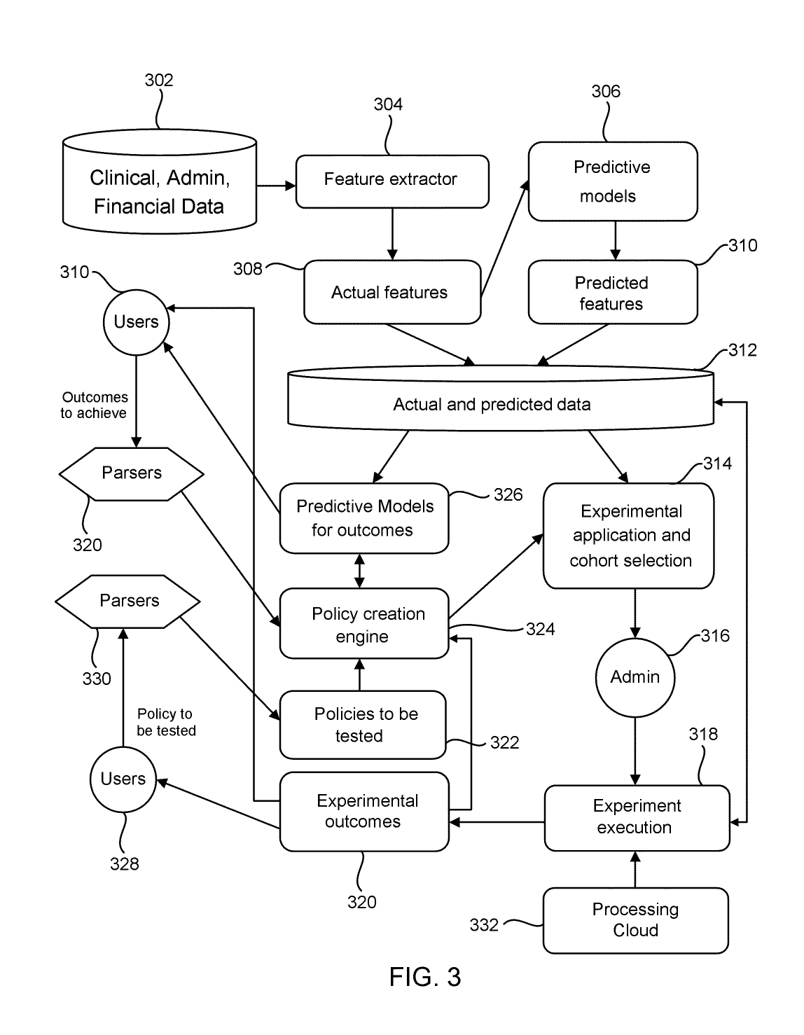

FIG. 3 illustrates a more detailed example of a system used for health care support. A database 302 can be used by a health care provider to store clinical and medical records, administrative data, and facility financial data in an electronic format. The database can be located on a database server with one or more processors to process the data. The database can be a relational database, object oriented database, flat file, or another known database format.

A feature extractor 304 can include data analysis modules configured to identify important features in the database information and clinical case data that may be used for statistical analysis. Each feature of the clinical records can be converted into a defined value representing an answer to a medical question. For example, the system may define whether there was heart failure, a patient has diabetes, or define other medical symptoms, related medical variables, or test results. All of these feature values can be stored as a data record or Boolean vector for each clinical, administrative or financial case.

The actual features 308 desired to be used in analysis phase can then be selected from the overall existing features so that certain selected features can be used in the multivariate statistical analysis. The predictive modeling can use the actual features selected in response to an end user's query criteria as input for the predictive models. Alternatively, clinical records may be selected randomly in order to automatically generate a randomized test over records containing actual features in a certain area of medical health or a random sample can be taken within a certain type of clinical disease test group. One or more predictive models 306 can be created to predict a defined effect of the health care policy based on a correlated feature set. The predictive models can also generate any predicted features 310 from the predictive models. These predictive features are features that are logically inferred from existing features. An actual and predicted feature database 312 can be configured to store actual features from the existing data and predicted features from the prediction models.

A predictive model module 326 can include one or more multivariate statistical models that may be used to test a health care policy with the correlated feature set data and predicted features stored in the actual and predicted features database 312. These models can predict what the outcome of certain applied health care policies may be and supply a corresponding probability value. These predictive models can be presented to users 310 so that the type of predictive models desired to be used can be selected by the users.

Users 310 can supply certain outcomes that are desired to be achieved by submitting logical rules, predicates or criteria that are passed through a parser 320. For example, a desired outcome may be to have treatments that are below a certain cost threshold or treatments that will use minimal amounts of certain kinds of untested drugs. These desired outcomes can be stored as rules in the policy creation engine 324.

At another point in the system interface, users 328 can also provide a health care policy to be tested. The health care policies can also pass through parsers 330 to check the syntax of the health care policies. The health care policies can be stored in a policies to be tested module 322. The policies to be tested can then be combined together with the desired outcomes from the policy creation engine in order to be added to the model profile for the predictive models 326. The health care policies, outcomes, and predictive models to be tested can also be copied to an experimental application module 314. The experimental application module also stores a selection of cohort information related to the experimental application. The experimental application and cohort selection passes through an administrative module 316 where an administrator can view the health care policy, the desired outcomes and the one or more predictive models being applied to the actual and predicted data.

When the administrator approves all the portions of the experimental application, then the application can be executed in the experiment execution module 318. In one embodiment, the experiment execution module can perform or be involved in the execution of physical experiments where a medical policy is clinically applied to one cohort of patients but not to another cohort or control group. The experiment execution module can be connected to medical machines that are collecting data from such clinical experiments or the experiment execution module can receive information collected after the clinical trials are completed. In an alternative embodiment, the execution of the experiment may be a simulation of a real experiment that can take place upon one or more servers or in a processing cloud 332. The processing may include one or more computing processors located on one more servers. The servers can be located at the health care facility, located remotely from the health care facility, or the processing pool may be a computing subscriber service where the experiment execution is off loaded to a remote computing cloud or computing grid.

The experiment execution produces experimental outcomes 320 that can be stored in a database or a computer memory. These experimental outcomes can be displayed on a display screen to the end users 328, 310 who have provided the health care policy being tested and the outcomes to be achieved.

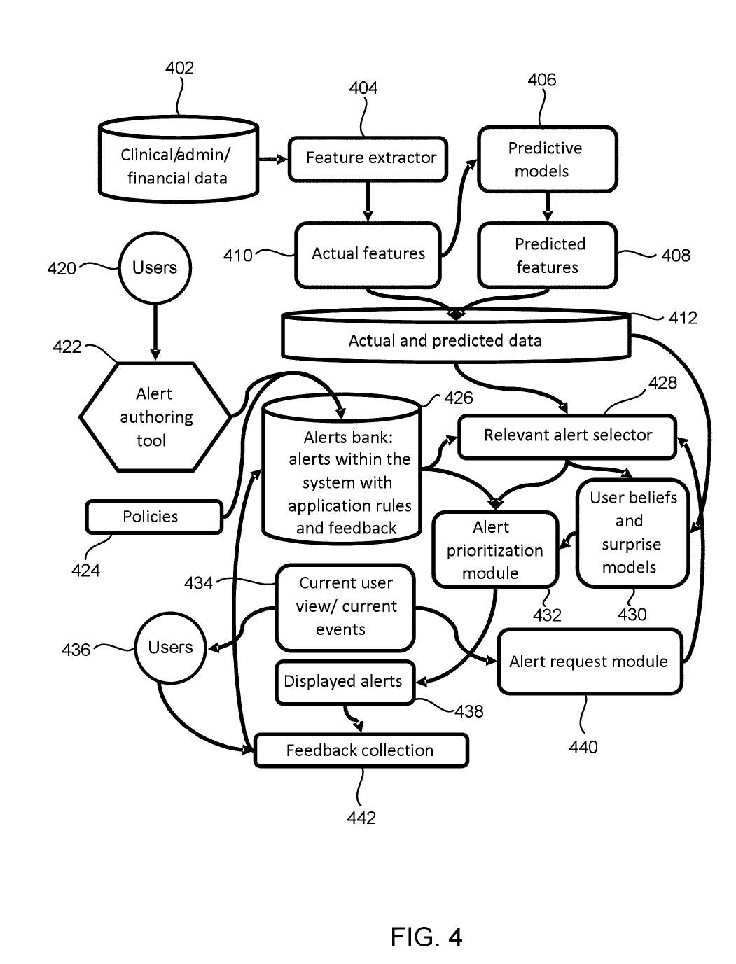

FIG. 4 illustrates a system for providing prioritized medical alerts in a health care administration system. Medical alerts can be generated using an alert authoring tool 422. The alerts can be created by users 420 who may include health care administrators, health care providers (e.g., physicians, nurses, etc.), or others trained to generate the alerts. The rules can be constructed based on deterministic logic, such as “display this alert for each patient with test result X”. Alternatively, the rules can be constructed based on probabilities from the analytics module, such as “display alert for patients with readmission probability >10%.”

The medical alerts may be stored in an alerts bank 426, which is a database for the health care information application. The alerts can also be stored with application rules, policies 424, and any user feedback received about the alerts. Examples of the medical alerts include alerts such as: unlikely medical events, unusual diagnoses that are more frequent in a specific geographic region, specific medical conditions that are seasonal in nature, medical events for certain demographics, unexpected medical conditions that can occur for high risk individuals, and other types of medical alerts.

A relevant alert selector 428 is provided in order to select the alerts which have been triggered using rules based on each of the decision support modules described previously. The operation of the database module 402, feature extractor 404, predictive models 406, actual feature selection module 410, predicted feature module 408 and actual and predicted data database 412 can operate in manner as described previously in FIG. 3.

A user beliefs and surprise models module 430 can be provided to create a model for analyzing and storing the user's belief and modeling the comparison of what constitutes a surprise. Typically, the user is a health care provider. The surprise modeling module can be configured to identify health care provider rules as a possible surprise occurrence when a health care provider's rating of lower occurrence probability as compared to a predicted probability of occurrence by a statistical prediction model. Such a surprise event can be displayed using a user interface control. In other words, the general belief among health care providers may be that a certain clinical event or diagnosis is unlikely, when in practice the statistical analysis reveals that the clinical event is more likely to occur than health care providers typically believe. In such cases, providing an alert is helpful to health care providers as a reminder of the surprise event. Such a surprise reminder can result in reduced disease diagnosis costs, increased accuracy of disease diagnosis, and increased overall health care quality.

A system can determine what a health care provider knows or what a health care provider's opinion of a certain type of diagnosis by tracking information that is available in the system and has been viewed, accessed, or entered by the health care provider. The system combines this information with prior statistical distributions for the clinicians' (i.e., users') knowledge, memories, tests ordered, typical measurements, and biases in different clinical contexts to create a current user model of the user's knowledge and beliefs. Thus, a model of what a health care provider generally knows is generated and specific actions by the health care provider within the system can be used to refine this logical model. The computerized system can keep track of potential low probability events (such as rare diseases and complications), and the system can maintain a probabilistic model for each of these events. By comparing the probabilities for these events with the estimated probabilities from the current user model, the system generates alerts for likely events that would surprise the user if the events were to occur.

An alert prioritization module 432 can be used to determine which alerts will be displayed and in what order the alerts with be displayed on a display screen to a community of health care providers. For example, the medical alerts can initially be prioritized and displayed to health care providers using a medical usefulness priority and community alert ratings. A medical usefulness priority can be created with the statistical modeling techniques and this will be described in further detail later. A discussion of community alert ratings will be discussed in more detail below. The alerts can be displayed separately, alongside the patient chart, on a scrolling notification bar, or in another format. Alternatively, alerts can be made available to the health care providers or practitioners through messages on a networked device or networked mobile device. Some alerts may be displayed in one output form but not necessarily in all other output forms. For example, ten alerts may be displayed along with a patient's medical chart, but only two of these displayed alerts may be urgent alerts that can be relayed to a mobile device due to their priority or relevance.

In some cases the number of alerts selected by the system to be displayed may exceed the available display area or the number of available display slots. In such cases, the system can select the alerts to be displayed using criteria such as urgency, relevance, the added value of the alert given the analytic model and/or the community rating.

In addition to being tied to a specific patient, alerts can be further contextualized based on the specific view within the system. For example, readmission alerts can be displayed in the discharge view, while information acquisition alerts can be made available in the lab-ordering view.

A feedback collection module 442 can be used to collect feedback for displayed alerts 438 from a plurality of health care providers in order to form community alert ratings for the medical alerts. The system can collect community feedback on the alerts using a survey method where a health care provider rates many alerts at one time, or a single question presentation format can present questions about individual alerts during the normal workflow. The feedback can be in a rating form (“Is the alert useful?”) where the user gives a “Yes” or “No” rating or numerical rating. Alternatively, the feedback can be provided in a text free-form entry box. The feedback may be used in at least two ways. First, the feedback can be provided back to the alert creator to refine/improve the rule's logic. Second, the score can also be incorporated into the display engine to enable the display of better-rated alerts at a higher position.

The prioritized medical alerts can then be displayed using a display engine 434 configured to display the medical alerts to a user 436 in a prioritized order based on the relevance ratings of the health care providers. In addition, the users or medical health care providers can view the currently suggested medical alerts and if the user feels the appropriate medical alerts are not being displayed, then the user can request that certain alerts retrieved in a query be displayed in certain situations. Any such requests can be sent back to the relevant alert selector 428 via an alert request module 440.

Surprise events, as described previously, can be placed in a separate graphical interface control or window to indicate that these are surprise events that are likely to surprise certain health care providers. In an embodiment, medical alerts can be displayed in conjunction with contextualized application views which correspond to a medical alert type. For example, one or more of the medical alerts can be displayed with a patient's medical chart. Using a medical alert reminder in this way is valuable because a health care professional is reminded of possible disease diagnoses that occur more often than the health care professionals' group intuitively believes the medical condition actually occurs.

The medical alerts can also be prioritized using a medical usefulness priority created with the statistical modeling techniques described above. Specifically, a correlated feature set can be built from the database related to a medical alert to be tested. The correlated feature set can be tested against a selection of existing health care cases to define a predicted medical usefulness probability for the medical alert. The medical usefulness priority can be defined based on the predicted medical usefulness probability for the medical alert. As a result, the medical alerts can be prioritized based on the statistical usefulness of the medical alert. This medical alert information may also be combined with the community rankings for the medical alert to form a medical alert ranking that is based partially on the opinions of health care providers and partially on the statistical ranking of the medical alert.

While the medical alerts may be obtained from the health care personnel, the medical alerts can also be constructed using deterministic logic applied to features of health care cases in the database. In other words, an analytics module (e.g., an inference engine or artificial intelligence module) can look for features using probabilities rules obtained from the analytics module to find situations with a potential alert value and the analytics module can construct possible medical alerts for the system. These possible medical alerts can then be presented to health care providers in a survey format to find out how likely the health care providers believe these events are to occur in real world situations. As described before, when the health care providers believe that the probability the medical situation will occur is lower than the actual occurrences of the event in medical practice, then this automatically generated alert can be presented as a “surprise event.” Alternatively, an automatically generated alert can be displayed because it has been rated as a useful alert.

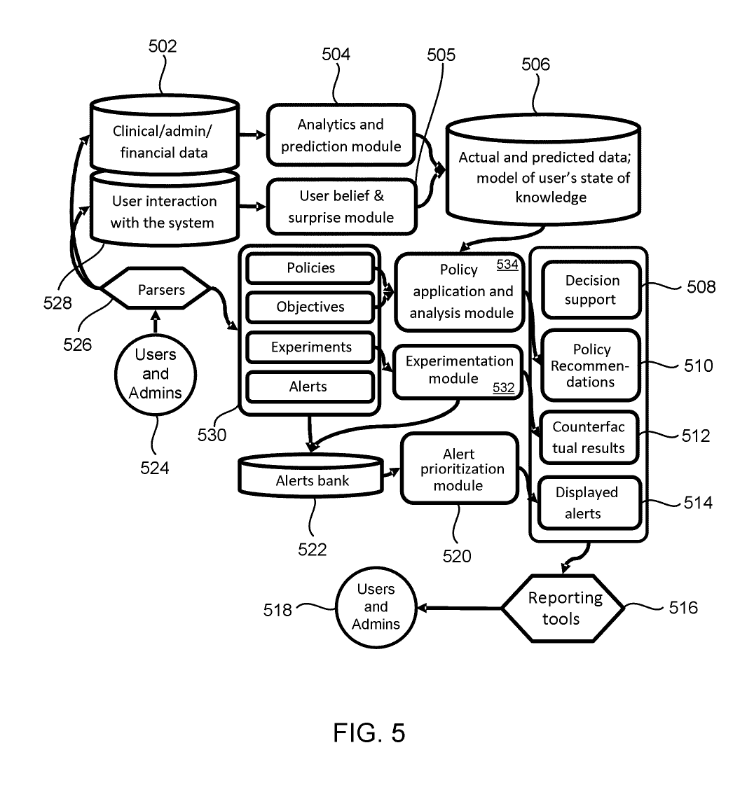

FIG. 5 illustrates an alternative system configuration for a health care system to provide alerts and multivariate statistical modeling. Users and administrators 524 can submit health care rules and modeling information to the system such as policies, objectives, experiments, and alerts 530. This detailed information can be submitted through a parser 526 which can check for syntax and some semantics and then can store the rules and modeling information. The medical alerts can be stored in an alerts bank 522 or database. The alerts can be prioritized using an alert prioritization module 520 which may be used to gather community feedback. Clinical, administrative, and financial data may be stored in one database 502, and user feedback for alerts and the user interactions with the system can be stored in another database 528. The health care information can be used in the analytics and prediction module 504, while the user feedback and user system interaction can be used by the user belief and surprise module 505. The prediction module will generate an actual and predicted data database 506 along with a statistical model of the users' state of knowledge. A policy application and analysis module 534 can determine what the results of applying a specific health care policy may be.

An experimentation module 532 can also process the user input. The experimentation platform can run on top of the analytics layer and enables the testing of new policies. The testing can be done counterfactually using causal reasoning on past cases. The testing can also be done on actual (future) cases. There are at least two ways to conduct an experiment with the purpose of testing a policy. The first one is using causal reasoning on past cases type of analysis (i.e., a “what would have happened” analysis). The second experimental method is using an actual experiment where future cases are divided into two or more groups, one group being the control group and the other(s) being the treatment group(s). The second method is much more reliable and is widely used in medical research. The first method has the advantage of being much cheaper, since the first method is not physically executed. The experimentation module 532 is capable of the first type 512 and the second type of experimentation (through alerts that facilitate the experiment 522). In this case, the system can receive a description of the policy being tested, and create appropriate randomized cohorts within the population to test the effects of the policy. In other words, the experiment generation module can automatically generate experiments using randomized trials administered by alternating between two policies and testing results. In the experimental trials, a policy is applied to a first random subset of a population to observe the effects of the policy on the control group. Then the other part of the population acts as the control group relative to the effects being measure. The system can then create a model for predicting the effect of the policy that the model can be incorporated into the analytics/decision module.

The output generated by these described modules can provide decision support 508, policy recommendations 510 for a health care facility, counter factual results 512, displayed alerts 514 and other related decision support statistics and summaries. All of this information can be accessed via reporting tools 516 used by the users and administrators 518.

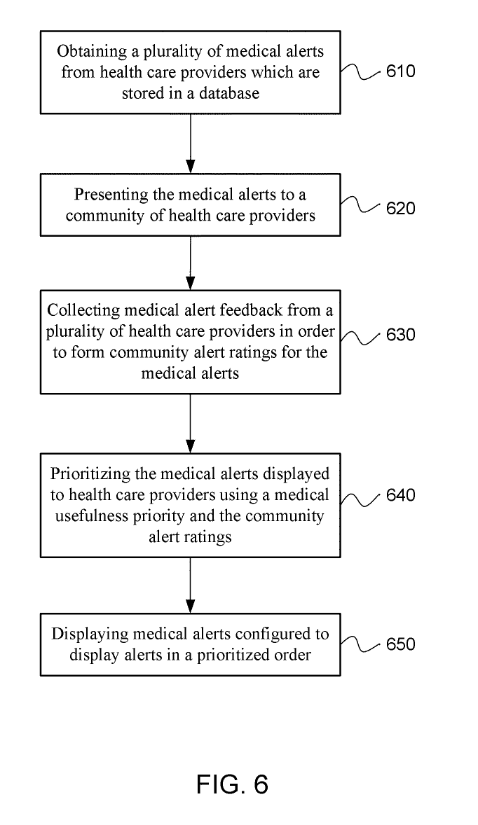

FIG. 6 illustrates a summary of technology which can be provided for prioritizing medical alerts in a health care information application. A plurality of medical alerts can be obtained from health care providers, and the medical alerts may be stored in a database for a health care information application, as in block 610.

The medical alerts can be presented to a community of health care providers, as in block 620. When the health care providers view the medical alerts, medical alert feedback can be collected from a plurality of health care providers in order to form community alert ratings for the medical alerts, as in block 630. The medical alerts can be prioritized and displayed to health care providers using a medical usefulness priority and the community alert ratings, as in block 640. The prioritized medical alerts can then be displayed using a display engine configured to display the medical alerts in a prioritized order, as in block 650. Tracking the opinion of health care providers by obtaining their personal opinion of how likely a medical condition is to occur is valuable because these observations can be shared with other health care providers, which automatically provides a health care provider (e.g., doctor) with opinions or observations from other health care providers in a fast and efficient manner.

The individual elements of the technology described in detail above can be implemented and used as stand-alone modules, without the need to implement the entire system. Alternatively, selected portions of the components can be used to provide selected functionality for the technology without detracting from the overall value of the technology.

### Example Implementation

An example of applying some portions of the technology described previously will now be described. Hospitals desire better ways of predicting whether patients' will be re-admitted to the hospital soon after the patients' discharge. Accurate predictions in this area can reduce the number of hospital readmissions. There are economic as well as clinical incentives for a hospital to reduce patients' re-admissions. While the re-admission probability for patients can be calculated based on the data available from the hospital information system, determining the result and cost of specific actions used to reduce hospital readmissions can be challenging.

For instance, there may be a desire to predict the probability that a patient will be readmitted to the hospital within 30 days of being released from the hospital. Based on that computed probability for re-admission, the present technology can identify an optimal health care policy for active patient follow-up to avoid hospital readmission. This active patient follow-up may include home visits, certain check-up periods, methods of electronic follow-up, etc.

In order to determine the results and costs of specific health care policies. The system may operate on data from a database with patient information from emergency room, hospital visits, and other medical information. The relevant features from the hospital information database regarding the patients and their visits can be identified using configurable parsers. An example of a hospital information database is the Amalga Hospital Information System developed by Microsoft Corporation. Areas of information where data features can be found may include: patient and bed management, laboratory and medication management, radiology information, pathology, stock management, and human resources systems. Examples of individual case features can include: patient's demographic, visit and triage info, complaint sentence text, attending health care provider, length of clinical stay, visit type, discharge date, prior visits data, current and prior diagnoses, and lab results.

The features of each patient's visit can be converted into a binary vector (f₁, f₂, f₃, f₄, . . . , f₉, . . . , fₙ) and there may be thousands or tens of thousands of binary features in the vector. A health care facility database may include hundreds of thousands of unique cases, patient admissions, or medical visits. Each feature represents answers to true/false questions such as whether the patients potassium level was high, whether the visit was on a weekend, the patients sex, whether the patient is having heart trouble, etc. Configurable parsers allow the end-user to add more feature parsers. Some features in the database can be populated and extracted in real-time, while others features are computed in a batch mode.

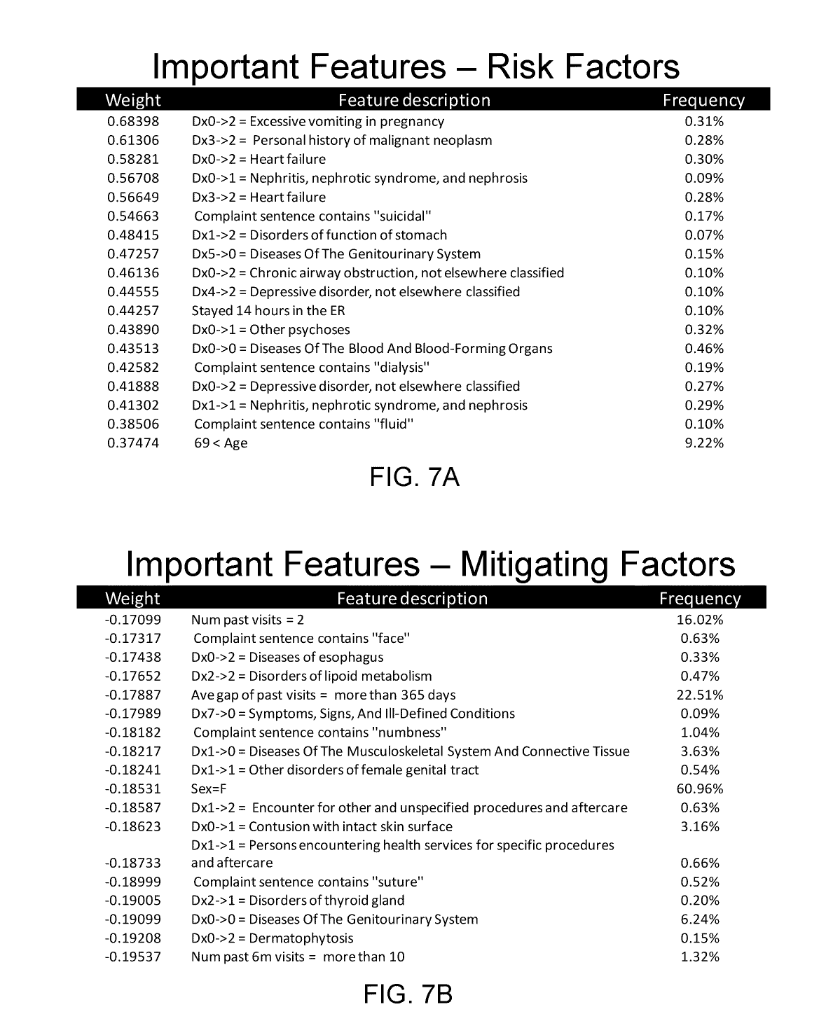

FIG. 7A illustrates a table of example features from a database which may be contributing factors to a readmission probability for a patient. Each risk feature may be associated with a weighting factor for the statistical analysis along with the frequency of occurrence of this factor in the database as compared to all the existing clinical records or clinical admission records. FIG. 7B illustrates a table of example features from a health care database that may be mitigating features which have a negative weighting and reduce the amount of risk a patient may have for being readmitted to a health care facility or hospital.

A model can be constructed and trained to predict a re-admission probability based on the relevant features. The statistical analysis model can include an adaptive learning capability which uses the feature sets applied to the hospital readmission problem. The adaptive model can be used to estimate the extent to which different features affect the readmission probability of a given patient. While a database may contain, tens of thousands of possible features to use in statistical analysis, there are probably less than one thousand features that may have any possible correlation to a target variable like readmission. The probability of patient's re-admission to the hospital or the emergency room can be modeled using a multivariate statistical analysis. An example of such statistical analysis is a sparse logistic regression function of a large set of features as in Equation 1 below.

$$P [ Readmission = True \vert {f}_{1} , … , {f}_{m} ] = \frac{{e}^{{\sum }_{i = 1}^{m} {f}_{i} {θ}_{i}}}{1 + {e}^{{\sum }_{i = 1}^{m} {f}_{i} {θ}_{i}}} \qquad Eq . 1$$

The logistic regression model allows the system to single out individual risk and mitigating factors pertaining to the specific patient and visit. In addition, the logistic regression model can be instantiated with parameters that are obtained by using information about prior visits and re-admissions.

The probability of a patient's readmission as well as the patient's relevant risk factors can be presented to a healthcare provider for evaluation at the time of the patient's discharge. For each new case, a predictive model can output the readmission probability for the patient. These probabilities can be used to highlight high-risk patients that account for the majority of readmissions. An example readmission table is shown below as Table 1. In the table, there are certain ranges on the statistical curve where a large percentage of the readmission patients are captured using a relatively low statistical predictor value.

TABLE 1

| Highlight % of patients | Readmission rate among | Capture % of all |
|---|---|---|
| using predictor. | selected group. | readmissions. |
| 10% | 17% | 48.6% |
| 20% | 11.9% | 68.3% |
| 30% | 9.1% | 78.4% |
| 100% | 3.5% | 100% |

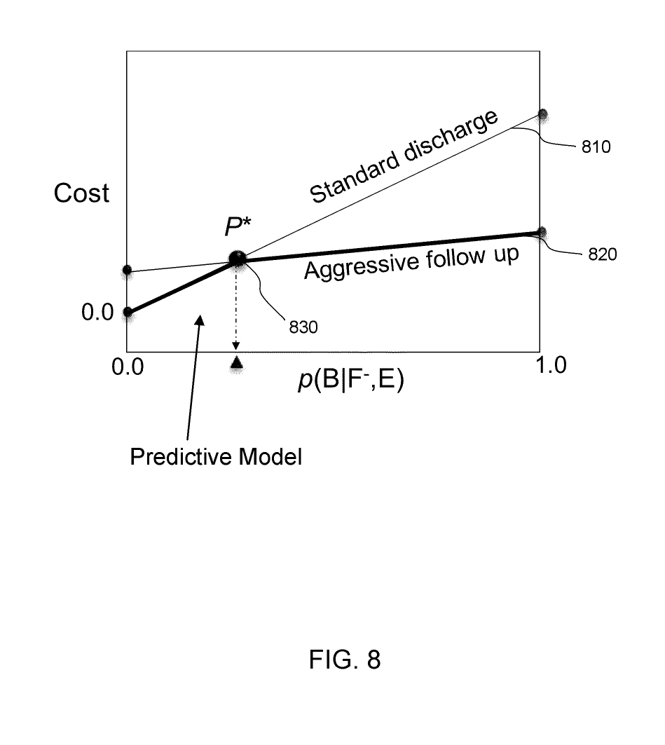

FIG. 8 illustrates an example output graph from an experimentation tool for decision making support. In the underlying determination, a status quo discharge policy from a hospital can be represented as (F⁻) which means that little or no follow-up is provided. A discharge policy with aggressive follow-up can be represented as (F⁺). In such computations, certain probabilities and costs may be fixed such as:

P(B|F⁻,E) is a probability of readmission without intervention

P(B|F⁺,E) is a probability of readmission with intervention

Cost (H,E) is the cost of readmission

Cost (F⁺) is the cost of readmission

With these fixed costs defined in advance from the database, a cost of the probability of readmission can be calculated as a straight line function in order to simplify the explanation. Other function distributions or function shapes can be used for the probability of readmission as desired. The first line is the standard discharge probability function 180 which is computed as the Expected Cost (F⁻,E)=p(B|F⁻,E) Cost (H,E). The second line is the aggressive follow-up probability function 820 which can be calculated as Expected Cost (F⁺,E)=p(B|F⁺,E) Cost (H,E)+Cost (F⁺).

In order to solve for the threshold probability where reductions in the number of readmission cases provides the desired level of savings, P* 830 can be computed as:

$${P}^{*} = \frac{Cost ( {F}^{+} )}{Cost ( H , E ) ( R ( {F}^{+} ) )}$$

where R is the reduction in the number of cases being readmitted. The calculation of P* in this simplified example graph is the intersection of the two lines. When the computed probability of an existing clinical case being readmitted to the hospital is above P* then the system can display an alert to the health care provider preparing to discharge the clinical case and patient. The alert can recommend to the health care provider that a certain high risk patient can have a defined level of aggressive follow-up in order to reduce the possibility readmission. When the computed probably is below the value P* then little or no follow-up can be applied.

In the example of FIG. 8, the value P* is fixed but in other embodiments the value of P* is determined by the system based on the amount of money desired to saved at a given point in time or other modifiable variables. The costs for follow-up treatment may be either determined as an amount fixed by a health care administrator or the cost for follow-up treatment may be calculated based on the resulting outcome desired by the health care administrator. In other words, a utility profile can be generated that represents the specific costs of certain procedures, follow-up costs, and costs on a per-patient basis. The utility profile can be used to compute whether the determined features should be recommended or not. The system also allows a user to define the cost model, cost functions, probability thresholds for triggering a health care rule, and related profile information. Alternatively, costs may also be inferred automatically from financial data within the system. In one embodiment, once the profile is in place for a patient being admitted to a hospital, a model can be a generated that will calculate the probability of other rules being applied to that patient.

The prediction analytics can track the cost of a certain follow-up treatment or procedure and then an alert can be displayed when the cost of certain procedures are above or below a certain threshold. As a result, a probability of a certain health care condition occurring can be calculated and the expected cost of a response to that probability is calculated. Then an alert can be generated to aid the administrator in making a decision about what response to the health care condition should be taken.

An example of an aggressive follow-up may be: two health care provider visits every 30 days, a defined number of phone calls during the 30 day period, and one scheduled appointment during the 30 day period. The cost of the aggressive follow-up may be $1,000, for example, where the cost of readmission may be $4,000 per day for a 5 day hospital stay which results in $20,000 of costs. So, a reduction (R) of the readmission case load by approximately 35% in such a case by using the calculated P* can save money for the health care provider. In this case, the computed probability is:

$${P}^{*} = \frac{\$1 , 000}{\$20 , 000 ( .34 )} = .143$$

By comparison if the follow-up cost is $2,000 then the P* will be greater where:

$${P}^{*} = \frac{\$2 , 000}{\$20 , 000 ( .35 )} = .286$$

Thus, where the follow-up cost is greater, the probably of readmission is desired to be greater before the aggressive follow-up is provided otherwise the follow-up is cost prohibitive and will not save the health care facility money.

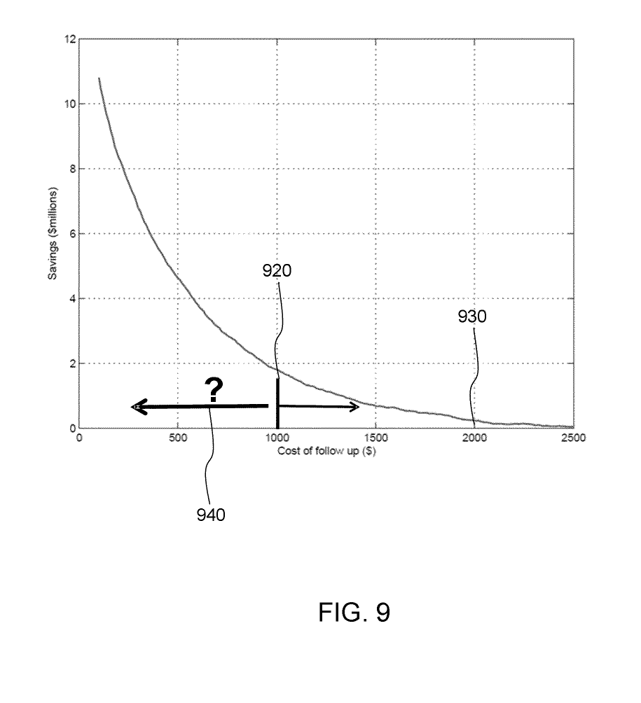

FIG. 9 further illustrates decision assistance calculations on a graph. Specifically, FIG. 9 illustrates the dependence between the cost of a follow-up policy and the realized savings to a facility when assuming the policy prevents 35% of facility re-admissions. For example, there may be 62,000 hospital facility visits within a month with 2,200 readmissions occurring within 30 days on average. Assuming an aggressive follow-up cost of $1,000 per case 920, then follow-up is unaffordable if a selective follow-up policy is not used because follow-up would cost $62 million dollars per month. An un-optimized follow-up policy will exceed the expect cost of readmissions of $44 million where each readmission is costing $20,000 per readmission. A similar issue arises where the amount of money is spent on the follow-up is not appropriately set. If the amount spent on follow-up is $2,000 per case visit then the overall follow-up is unaffordable at $124 million and exceeds the expected cost of readmission. Thus, the predictive model can be used to determine the appropriate dollar value 940 to be spent on follow-up care.

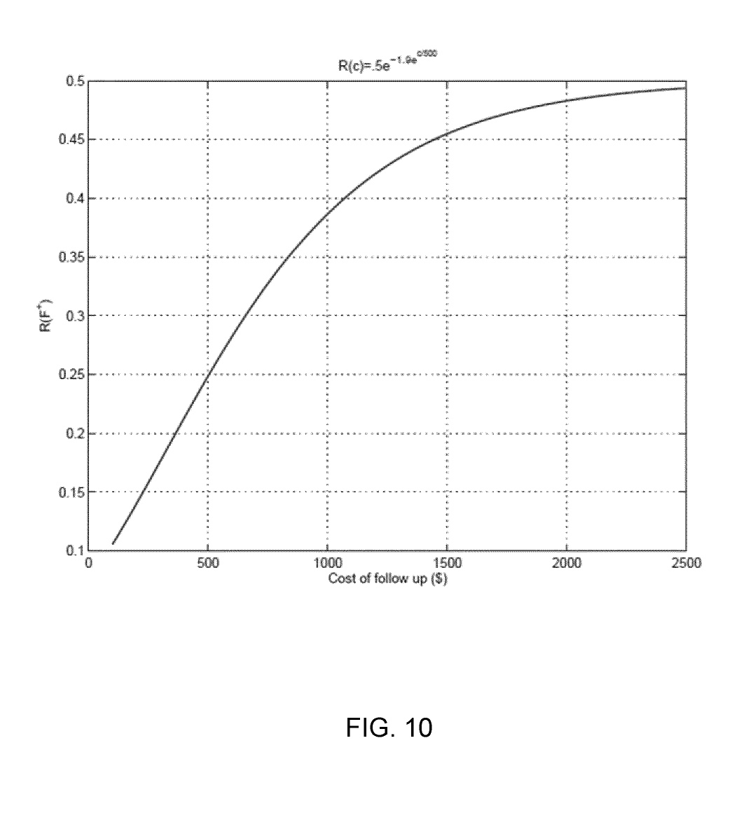

FIG. 10 illustrates a graph of an embodiment of the predictive model where increasing amounts of follow-up care with increasing costs can be administered to those who have the highest risk of re-admission. For example, a patient who has a 48% chance of being readmitted may have a follow-up care administered to the patient costing $2,000 while a patient with a 25% reduction in being readmitted may have $500 of follow-up care administered to them. While a patient with a very low probability of being readmitted to the health care facility may have little or no follow-up care administered to the patient because their risk is so low. This strategy enables the amount of care that is applied to a patient to vary in response to the varying probability they may be readmitted. Other factors and costs in the analysis model can be varied in the same way. Varying parts of the model impacts the patients profile and the final probability outcome, which in turn affects the health rules applied to the patient's case.

To reiterate, the present technology is configured to apply machine learning and decision analysis for insights and real-time support of a health care management system. In addition, statistical analysis can be used to provide predictions for experimental health care policies or rules and to provide decision support.

Some of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more blocks of computer instructions, which may be organized as an object, procedure, or function. Nevertheless, the executables of an identified module need not be physically located together, but may comprise disparate instructions stored in different locations which comprise the module and achieve the stated purpose for the module when joined logically together.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices. The modules may be passive or active, including agents operable to perform desired functions.

Furthermore, the described features, structures, or characteristics may be combined in any suitable manner in one or more embodiments. In the preceding description, numerous specific details were provided, such as examples of various configurations to provide a thorough understanding of embodiments of the described technology. One skilled in the relevant art will recognize, however, that the technology can be practiced without one or more of the specific details, or with other methods, components, devices, etc. In other instances, well-known structures or operations are not shown or described in detail to avoid obscuring aspects of the technology.

Although the subject matter has been described in language specific to structural features and/or operations, it is to be understood that the subject matter defined in the appended claims is not necessarily limited to the specific features and operations described above. Rather, the specific features and acts described above are disclosed as example forms of implementing the claims. Numerous modifications and alternative arrangements can be devised without departing from the spirit and scope of the described technology.

1. A method for developing health care policies for use in a health care facility using health care data stored in a health care database, comprising:
obtaining a health care policy configured to be applied in a health care software application and stored in the health care database;
building a correlated feature set from the health care database, and the correlated feature set is configured to be correlated to the health care policy being developed;
obtaining a selection of health care cases from the health care database for testing the health care policy;
creating a model to predict a defined effect of the health care policy based on the correlated feature set; and
predicting a cost of implementing the health care policy using the defined effect by the model and a specified predictor by applying statistical analysis to the health care policy.

2. The method as in claim 1, wherein the model used to predict the defined effect of the health care policy is a statistical model configured to be trained using a multivariate statistical correlation model.

3. The method as in claim 1, wherein the model used to predict health care policy effects uses causal reasoning applied to features of existing health care cases.

4. The method as in claim 1, wherein obtaining a selection of health care cases further comprises:
obtaining a randomized selection of health care cases from the health care database; and
integrating data from a plurality of health care facilities located at separate geographic locations.

5. The method as in claim 1, wherein a health care policy is a health care rule that includes health care treatment recommendations for a patient when the health care rule is triggered.

6. The method as in claim 1, further comprising testing the health care policy and correlated feature set using the selection of existing health care cases to determine when the application of a health care policy is beneficial for health care cases at the health care facility.

7. The method as in claim 1, wherein a feature set for a health care case is encoded as a vector of binary features representing binary responses to a health care patient's medical symptoms and relevant medical variables.

8. A method for prioritizing medical alerts in a health care information application, comprising:
obtaining a plurality of medical alerts from health care providers which are stored in a database;
presenting the medical alerts to a community of health care providers;
collecting medical alert feedback from a plurality of health care providers in order to form community alert ratings for the medical alerts; and
prioritizing the medical alerts displayed to health care providers using a medical usefulness priority and the community alert ratings to form a prioritized order; and
displaying medical alerts using a display engine configured to display the medical alerts in the prioritized order.

9. The method as in claim 8, further comprising:
building a correlated feature set from the database related to a medical alert to be tested;
obtaining a selection of existing health care cases for testing the medical alert policy;
testing the medical alert using the correlated feature set on existing health care cases in the database to define a predicted medical usefulness probability for the medical alert; and
defining a medical usefulness priority for the medical alert based on the predicted medical usefulness probability for the medical alert.

10. The method as in claim 8, further comprising:
tracking medical alerts having a health care provider's rating of lower estimated occurrence probability as compared to a predicted probability of occurrence by a statistical prediction model;
displaying medical alerts that have a lower estimated occurrence probability as compared to a predicted probability of occurrence.

11. The method as in claim 8, further comprising displaying alerts with a low probably of occurrence as surprise events viewable by a health care provider.

12. The method as in claim 8, further comprising constructing the plurality of medical alerts using deterministic logic applied to features of health care cases in the database.

13. The method as in claim 8, further comprising constructing the plurality of medical alerts using probabilities obtained from an analytics module.

14. The method as in claim 8, further comprising displaying at least one of the plurality of medical alerts with a patient's medical chart.

15. The method as in claim 8, further comprising displaying medical alerts in conjunction with contextualized application views that correspond to a medical alert type.

16. A system for health care support, comprising:
a health care database used by a health care provider, the health care database having a plurality of medical case records;
a parser module having a library of data parsers configured to convert the medical case records into medical data vectors;
an analytics module configured create a model to predict a defined effect of the health care policy based on a correlated feature set;
a decision support module configured to obtain a selection of existing medical case records for testing the health care policy; and
a predictive model module configured test a health care policy with the correlated feature set using the selection of existing medical case records in the health care database to determine a desirable application rate for applying the health care policy at the health care facility.

17. The system as in claim 16, wherein the analytics module further comprises a causality module configured to provide inferred rules linking defined medical features to medical outcomes based on causality.

18. The system as in claim 16, further comprising an a feedback collection module configured to accept health care provider alerts and to receive aggregate feedback from health care professionals in order to form a prioritization of health care provider alerts.

19. The system as in claim 16, further comprising a surprise modeling module configured to identify health care provider rules having a health care provider's rating of lower occurrence probability as compared to a predicted probability of occurrence by a statistical prediction model as a possible surprise occurrence using a user interface control.

20. The system as in claim 16, further comprising an experiment generation module configured to automatically generate experiments using randomized trials administered by alternating between two policies sets and testing results.
